(19) United States
(12) Patent Application Publication
(10) Pub. No.: US 2014/0356095 A1
(43) Pub. Date: Dec. 4, 2014

(54) CAPTIVE RETAINING MEANS FOR A FASTENING SCREW ON A COMPONENT

(71) Applicant: IBS Filtran Kunststoff-/ Metallerzeugnisse GmbH, Morsbach (DE)

(72) Inventors: Marc Buchen, Morsbach (DE); Jorge Jaspers, Morsbach (DE)

(73) Assignee: IBS Filtran Kunststoff-/ Metallerzeugnisse GmbH, Morsbach (DE)

(21) Appl. No.: 14/282,487

(22) Filed: May 20, 2014

(30) Foreign Application Priority Data
May 28, 2013 (DE) 10 2013 008 983.2

(51) Int. Cl. F16B 39/24

(52) U.S. Cl. CPC F16B 39/24
USPC 411/112

(57) ABSTRACT

The invention relates to a captive retaining means for a fastening screw (5) on an oil sump (1), said fastening screw passing through a penetration opening (4) in the oil sump (1), wherein the oil sump (1) can be arranged with respect to a gearbox housing or engine housing in such a manner that the penetration opening (4) is approximately aligned with a connection opening in the engine housing or gearbox housing, and that the fastening screw (5) is insertable into the connection opening, wherein the captive retaining means comprises at least one clamping bushing (16) which engages non-positively around a threaded stem (6) of the fastening screw (5), wherein the clamping bushing (16) is inserted directly into the penetration opening (4) and is fixed axially therein, and wherein the clamping bushing (16) is mounted in a floating manner in the circumferential direction in the penetration opening (4).

The invention relates to a captive retaining means for a fastening screw on a component, said fastening screw passing through a penetration opening in the component, wherein the component can be arranged with respect to a connection component in such a manner that the penetration opening is approximately aligned with a connection opening in the connection component, and that the fastening screw is insertable into the connection opening, wherein the captive retaining means comprises at least one first clamping bushing which engages around a threaded stem of the fastening screw and is in engagement with said threaded stem in such a manner that the threaded stem is fixed non-positively in the clamping bushing.

The invention relates in particular to a housing cover made from plastic on an engine housing or gearbox housing made from metal in an internal combustion engine, said housing cover being secured by a plurality of fastening screws against the housing, in particular a gearbox oil sump made from thermoplastic.

A captive retaining means of the type mentioned at the beginning is known, for example from DE 200 10 252 U1. DE 200 10 252 U1 relates to an oil sump which is fastenable to a crankshaft housing of an internal combustion engine, wherein the oil sump has a fastening flange with screw penetration perforations, and cap screws which are inserted through the perforations and are screwable into a threaded bore, which is coaxial thereto, in the engine part are provided, wherein, furthermore, a seal is arranged between the flange and the engine part, and a cage-like shaped sheet-metal part is pressed into the perforation in the flange of the oil sump, said shaped sheet-metal part having a through channel which is coaxial with respect to the perforation, wherein the through channel captively holds a sleeve-like plastics insert, through which the stem of the cap screw is passed, wherein the stem is held in the plastics insert so as to be frictionally secured against axial displacement.

This solution is based on the problem, in the case of oil sumps composed of metal or of steel, of providing easier assembly for the automated screw connection. Instead, as customary, of supplying the corresponding individual parts, such as oil sump, seal and screws, separately, it is advantageous, for robot assembly or conveyor line assembly, to supply at least the fastening means in a correct position to the engine part to which the oil sump is intended to be fastened.

For this purpose, it is proposed in DE 200 10 252 U1 to provide a metal oil sump in which a cage-like shaped sheet-metal part is pressed into the perforation in the flange of the oil sump, the through channel of which shaped sheet-metal part holds a sleeve-like plastics insert as a captive retaining means for the fastening means or for the cap screw, with the stem of the cap screw passing through said plastics insert, and with the stem of the cap screw being fixed in the plastics insert in a frictional manner.

By this means, it is possible to provide the oil sump with the fastening screws arranged thereon in premanufactured form to an assembly line. The fastening screws are held captively on the oil sump, wherein it is ensured at the same time that the screws take up the predetermined assembly position relative to the oil sump.

However, this solution is disadvantageous in that possible alignment errors between the penetration openings on the oil sump and the corresponding fastening bores on the housing of the internal combustion engine inevitably result in reliable automated fastening of the oil sump to the gearbox housing no longer being possible.

Moreover, the manufacturing of the oil sump described in DE 200 10 252 U1 is relatively complicated since a cage-like shaped sheet-metal part has to be pressed into the perforation in the flange of the oil sump composed of metal. This requires a separate working step for the production of the oil sump.

Since, as is known, certain dimensional tolerances due to the shaping process, for example due to shrinkage of the material, occur in shaped plastics parts, it is known and necessary to design the penetration openings in plastics components with such an excess size that positional tolerances or alignment tolerances can be compensated for.

The invention is therefore based on the object of simplifying a captive retaining means of the type mentioned at the beginning in respect of produceability. Furthermore, the invention is based on the problem of designing the captive retaining means according to the type mentioned at the beginning in such a manner that said captive retaining means can be produced in a simple manner even in the case of components made from plastic, in particular in the case of housing covers or oil sumps made from plastic.

The object on which the invention is based is achieved by a captive retaining means with the features of Claim 1. Preferred refinements of the invention emerge from the dependent claims.

According to the invention, a captive retaining means is provided for a fastening screw on a component, said fastening screw passing through a penetration opening in the component, wherein the component can be arranged with respect to a connection component in such a manner that the penetration opening is approximately aligned with a connection opening in the connection component, and that the fastening screw is insertable into the connection opening, wherein the captive retaining means comprises at least one first clamping bushing which engages around a threaded stem of the fastening screw and is in engagement with said threaded stem in such a manner that the threaded stem is fixed non-positively in the clamping bushing, wherein the clamping bushing is fixed axially in the penetration opening, and the captive retaining means is distinguished in that the clamping bushing is inserted directly into the penetration opening, and in that the clamping bushing is shiftable in the radial direction in the penetration opening.

In other words, the clamping bushing is mounted in a floating manner in the radial and/or in the circumferential direction in the penetration opening, such that, according to the invention, compensation for positional tolerances is possible during the automated assembly of the component.

The diameter of the penetration opening is expediently selected to be approximately 10% to 40%, preferably approximately 25% larger than the nominal diameter of the fastening screw, wherein the clamping bushing is inserted directly into the penetration opening so as to be freely shiftable, i.e. in a floating manner, in the circumferential direction.

This has the advantage of making it unnecessary to press in receiving structures for the clamping bushing, and therefore the component can be designed relatively more simply. Furthermore, the solution according to the invention has the advantage that the fastening screws are shiftable transversely with respect to the fastening direction thereof within the penetration openings by the excess size of the penetration openings with respect to the nominal diameter of the fastening screws such that, during automated assembly, the fastening screws readily find their way into the associated thread.

The component is preferably composed of thermoplastic, for example of a glass-fibre-reinforced polyamide with a fill factor of approximately 10 ma % to 60 ma %.

In a particularly preferred variant of the captive retaining means according to the invention, it is provided that the component has a receiving pocket for the clamping bushing, wherein the receiving pocket forms an undercut of the penetration opening. A receiving structure of this type for the clamping bushing is geometrically relatively simple and especially permits a relatively simple completion of the component which is produced, for example, by injection moulding.

In an advantageous and expedient variant of the captive retaining means according to the invention, it is provided that the receiving pocket has at least one window which defines a circumferential break-through of the penetration opening and through which the clamping bushing is insertable into the receiving pocket, wherein the outside diameter of the clamping bushing is larger than the clear width of the penetration opening.

Such a structure of the penetration opening makes it possible to insert the clamping bushing into the receiving pocket in a relatively simple manner, to be precise through the window provided in the receiving pocket. The clamping bushing here does not have to be arranged captively per se in the receiving pocket; the captive retention can be produced, for example, by completion with the fastening screw.

If the component is in the form of, for example, a housing cover or an oil sump, the penetration opening is expediently provided in a fastening flange or in a fastening eye integrally formed on the fastening flange. The window can then be turned, for example, towards the encircling edge of the fastening eye such that the clamping bushing concerned can be inserted relatively simply into the penetration opening transversely with respect to the longitudinal extent of the penetration opening through the window.

In another advantageous variant of the captive retaining means according to the invention, the clamping bushing is latched axially in the penetration opening. Such a variant can be completed in a particularly simple manner after the component has been finished.

The clamping bushing can have, for example, at least two latching springs which engage behind at least one latching projection in the duct, and therefore the clamping bushing can be inserted or can be clipped in a relatively simple manner into the duct.

So that the clamping bushing is secured in both possible axial directions within the penetration opening, said clamping bushing is expediently provided with at least one insertion-limiting stop which can be supported, for example, on an encircling collar in the penetration opening, wherein the collar forms a latching projection, behind which the latching springs engage.

Instead of a single encircling collar, it is also possible for projections which are distributed over the circumference of the penetration opening and project into the penetration opening to be provided discretely. It is advantageous and expedient here if at least two projections are provided. An arrangement with three projections, on which one or more insertion-limiting stops of the clamping bushing can be supported, is also favourable.

The outside diameter of the clamping bushing is expediently partially smaller than the clear width of the penetration opening such that, when the clamping bushing is inserted axially into the penetration opening and is latched therein, the clamping bushing is nevertheless shiftable in the circumferential direction within the penetration opening.

In a furthermore advantageous and simple variant of the captive retaining means according to the invention, it is provided that a second clamping bushing is provided, said clamping bushing engaging around the stem of the fastening screw at a distance from the first clamping bushing, wherein the clamping bushings are each supported on an encircling step or on a plurality of projections in the penetration opening. For example, the penetration opening can be lowered in each case on both sides, i.e. can have a diameter which is significantly larger than the diameter of the clamping bushings, and therefore one clamping bushing can be inserted from each side into the penetration opening. By engagement of the stem of the fastening screw in the clamping bushings, the clamping bushings are then held captively at the respective ends of the penetration opening.

The clamping bushings expediently have inwardly projecting clamping jaws or clamping cams which form an interference fit with the stem of the fastening screw such that the stem of fastening screw can be inserted into the clamping bushing in a frictional manner.

The clamping bushing is advantageously composed of thermoplastic.

The component according to the invention can be, for example, a housing cover for an engine housing or a gearbox housing. Said component can be in the form, in particular, of a gearbox oil sump or engine oil sump made from plastic and can have a fastening flange with a plurality of penetration openings arranged at a distance from one another.

The penetration openings are expediently designed as substantially circular holes in an encircling fastening flange or in fastening eyes of an encircling fastening flange, wherein the holes or ducts are designed in the inside in such a manner that at least one clamping bushing can be fixed axially and in an interlocking manner therein.

The invention is explained below with reference to the attached drawings, in which

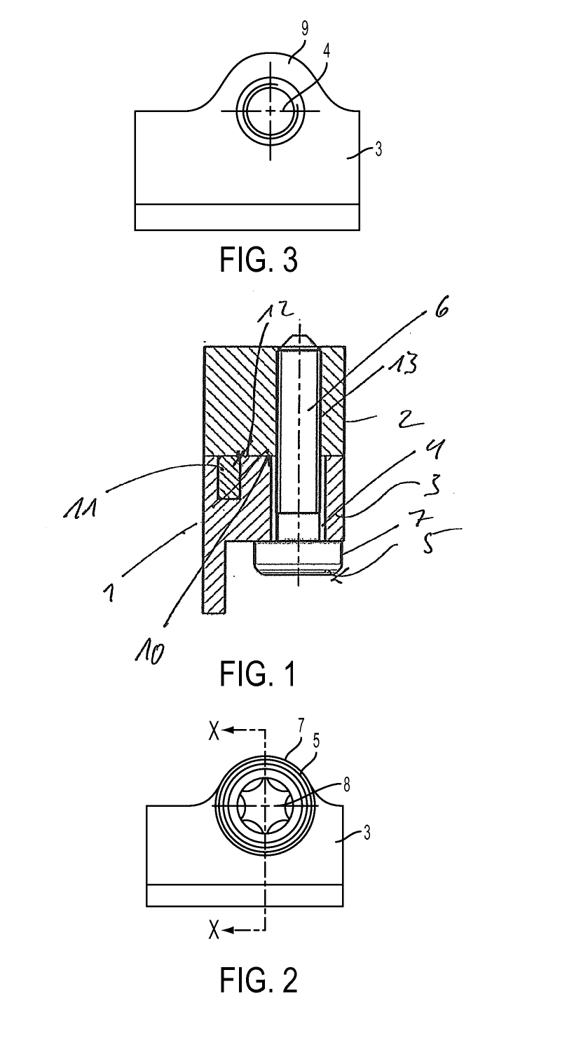

FIG. 1 shows a sectional view through an oil sump, which is fastened to a gearbox housing, in the connecting region,

FIG. 2 shows a top view of the fastening flange of the oil sump according to FIG. 1,

FIG. 3 shows a top view corresponding to FIG. 2 without the fastening screw,

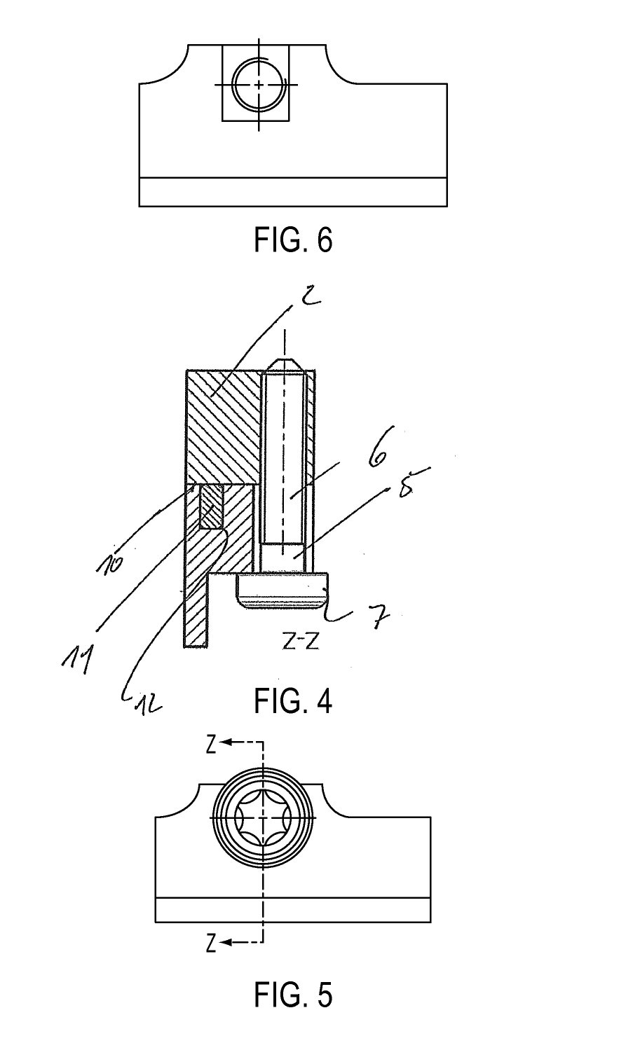

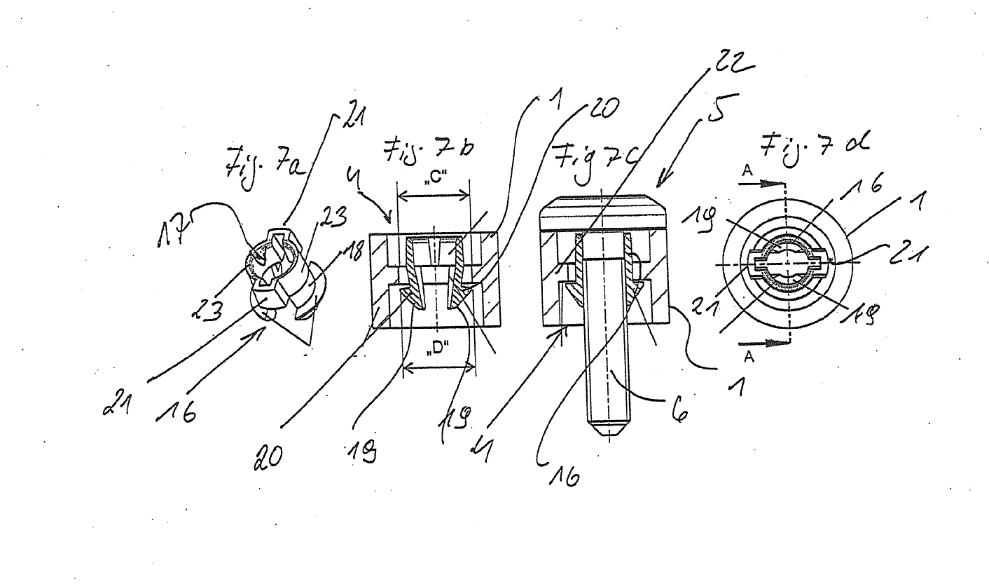

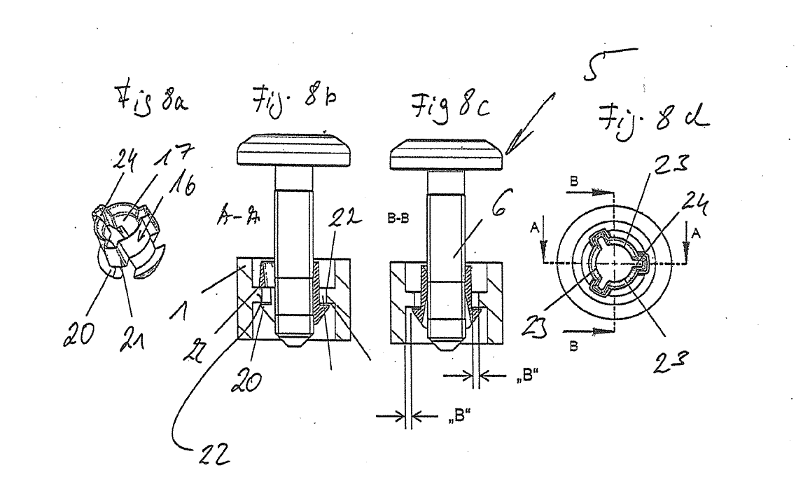

FIGS. 4 to 6: show a view, corresponding to FIGS. 1 to 3, of a second exemplary embodiment according to the invention,

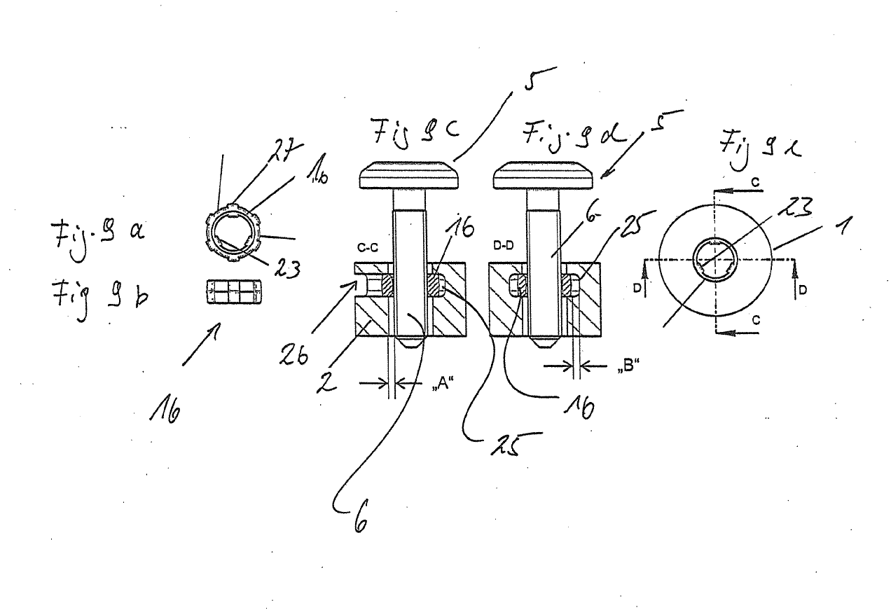

FIGS. 7a to 7d: show a first variant of a captive retaining means for the fastening screws on a housing cover according to the invention,

FIGS. 8a to 8d: show a second variant of the captive retaining means shown in FIGS. 7a to 7d,

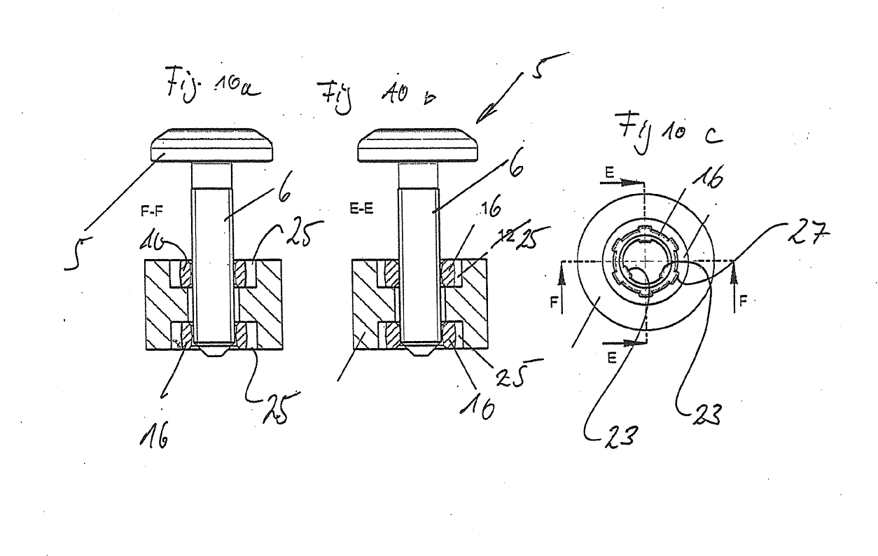

FIGS. 9a to 9e: show a further variant of a captive retaining means for a fastening screw on a housing cover according to the invention, and

FIGS. 10a to 10c: show a fourth variant of a captive retaining means for a fastening screw on a housing cover according to the invention.

In the drawings, the housing cover in the form of an oil sump 1 made from thermoplastic for a gearbox housing 2 on an internal combustion engine is not completely illustrated; rather, only a partial section in the region of a screw connection is illustrated.

The oil sump 1 is essentially in the form of a cover-shaped, trough-shaped structure with an encircling fastening flange 3 and a multiplicity of penetration openings 4, which pass through the fastening flange 3 at a distance from one another and are intended for fastening screws 5. The fastening screws 5 comprise a threaded stem 6 with a preferably metric thread and with a screw head 7 with a hexagon socket 8. In the exemplary embodiment of the housing cover according to the invention illustrated in FIGS. 1 to 3, the penetration openings 4, only one of which is illustrated, are in each case provided in fastening eyes 9 integrally formed on the fastening flange 3. The oil sump 1 is tightened in an encircling manner up against a corresponding bearing surface (countersurface) 10 of the gearbox housing 2 via the fastening screws 5. The gearbox housing 2 is composed of aluminium or of a comparable light metal, whereas the oil sump 1 is composed of a glass-fibre-filled polyamide, with the fibre filling being between 30 and 35 ma %.

To seal the oil sump 1 against the gearbox housing 2, the oil sump 1 comprises a sealing ring 11 which is made from an elastomeric material which is accommodated by an encircling groove 12 in the fastening flange 3.

As can be gathered in particular from FIGS. 1 and 4, the fastening screw 5 penetrates the penetration opening 4 and a threaded bore 13, which is aligned with respect thereto, in the gearbox housing, wherein the threaded stem 6 of the fastening screw 5 is in engagement with the thread of the threaded bore 13.

The sealing ring, which is denoted by 11, in uncompacted form has a larger volume than the volume of the groove 12 accommodating said sealing ring, and therefore, in the case of a fastening screw 5 tightened according to the specifications, the sealing ring 11 is compressed. The restoring force of the sealing ring 11 acts here counter to the screw-tightening force in the direction of the longitudinal axis of the fastening screw 5. If the fastening screw 5 has, for example, a threaded stem 6 with an M6 thread, said fastening screw can have been tightened, for example, with a screw-tightening torque of 10 Nm with a screw-prestressing force of approximately 10 kN.

The penetration opening 4 has an excess size of approximately 10 to 40%, preferably of 25%, in relation to the nominal diameter of the fastening screw 5.

The gap size of the separating gap 15 between the bearing surface 10 of the gearbox housing 2 and the sealing surface 14 of the fastening flange is ideally 0, to be precise without taking the microroughness of the surfaces resting on one another into consideration.

As is apparent from the drawings, the screw head 7 of the fastening screw 5 is supported directly on the fastening flange 3, i.e. without the use of an otherwise customary metal supporting sleeve.

By this means, it is basically possible to keep the diameter of the circular penetration opening 4 illustrated in FIGS. 1 to 3 relatively small, and therefore the width of the fastening flange 3 can likewise be selected to be relatively narrow.

As can be gathered in particular from FIGS. 4 to 6, it is not absolutely necessary to configure the penetration opening 4 as a circular bore; on the contrary, said penetration opening can also be in the form of a rectangular or cross-sectionally U-shaped break-through in the fastening flange 3.

The exemplary embodiment according to FIGS. 4 to 6 of the figures of the drawing differs in this respect from the exemplary embodiment illustrated in FIGS. 1 to 3.

Reference is now made to FIGS. 7 to 10 which show a captive retaining means for a fastening screw on the housing cover according to the invention.

If the fastening screws 5 can be premounted captively on the oil sump 1, assembly is made substantially easier. As already mentioned at the beginning, said fastening screws are preferably held on the gearbox housing 2 in such a manner that compensation for the positional tolerances of the fastening screws 5 is possible in each case. Compensation of positional tolerances should be understood as meaning compensation for possible alignment tolerances between the penetration openings 4 in the oil sump 1 and the threaded bores 13 in the gearbox housing 2.

Reference is made first of all to the exemplary embodiment according to FIGS. 7a to 7d. A section through a penetration opening 4 in the housing cover or oil sump 1 is illustrated in particular in FIGS. 7b and 7c. For simplification reasons, the gearbox housing 2 or the connection component is not illustrated.

A clamping bushing 16 is inserted into the penetration opening 4 which is, in the case of the exemplary embodiment according to FIGS. 7a to 7d, in the form of a circular bore. The clamping bushing 16 is latched in the circular penetration opening 4, wherein said clamping bushing is fixed axially by the latching, but nevertheless is mounted so as to be shiftable in the circumferential direction, i.e. in a floating manner, within the penetration opening 4.

The clamping bushing, for example in the form of a plastics component, is injection moulded from polyamide, polyethylene, ABS or the like. Said clamping bushing defines an approximately cylindrical receiving space 17 which forms two opposite clamping jaws 23. The guiding end of the clamping bushing 16 comprises two latching springs 18 which are arranged opposite each other and in each case form sliding ramps 19 which are bevelled in the direction of the guiding end of the clamping bushing 16 and in each case form latching hooks 20 which are of arrow-shaped design in cross section.

The guiding end of the clamping bushing 16 within the context of the present application means the end which forms the guiding end when the clamping bushing 16 is inserted into the penetration opening 4 concerned.

At that end of the clamping bushing 16 which is remote from the latching springs 18, said clamping bushing is provided with two insertion-limiting stops 21 which are arranged diametrically opposite each other and are offset by 90° with respect to the latching springs 18.

The clamping bushing 16 illustrated in FIG. 7a, as illustrated in FIG. 7b, is inserted with the guiding end thereof into the penetration opening 4 in such a manner that, in the fitted position of the clamping bushings 16, latching hooks 20 engage behind an encircling latching projection 22 in the penetration opening 4. In this position, the insertion-limiting stops 21 are supported on the encircling latching projection 22 such that the clamping bushing 16 is fixed axially.

The clear width C of the penetration opening 4 is somewhat smaller than the largest diameter D of the clamping bushing 16 at the largest circumference of the latching hooks 20. In the region of the latching springs 18 below the clamping jaws 23 of the clamping bushing 16, the clamping bushing 16 has an outside diameter which is smaller than the clear width C, and therefore the clamping bushing 16 is shiftable in the circumferential direction, i.e. is inserted into the penetration opening in a floating manner.

In the region of the clamping jaws 23, the receiving space 17 has a clear width which is slightly smaller than the nominal diameter of the fastening screw 5, and therefore the fastening screw 5 can be inserted into the receiving space 17 of the clamping bushing 16 with a press fit being formed. The fastening screw 5 is held in the clamping bushing 16 in such a manner that said fastening screw is movable axially into the clamping bushing 16 only counter to resistance. The clamping bushing 16 is, in turn, fixed axially within the penetration opening 4 and is shiftable therein in the circumferential direction, i.e. transversely with respect to the longitudinal extent of the fastening screw 5, wherein the size of the shift corresponds to the maximum compensation for positional tolerances for the fastening screw 5.

All of the fastening screws 5 on an oil sump 1 can thereby be fixed captively within the penetration openings 4 concerned. A possible alignment error or alignment tolerance between the penetration openings 4 in the oil sump 1 and the threaded bores 13 in the gearbox housing 2 can be compensated for by the radial play of the clamping bushings 16 in the penetration openings 4 concerned.

Instead of a single encircling latching projection 22 within the penetration opening 4, it is possible, for example, for a plurality of latching projections distributed discretely over the circumference of the duct opening to be provided.

An alternative configuration of the captive retaining means is illustrated in FIGS. 8a to 8d, wherein there, as in the exemplary embodiments below, functionally identical components are provided with the same reference numbers.

The exemplary embodiment described in FIGS. 8a to 8d differs from the exemplary embodiment described in FIGS. 7a to 7d in so far as the clamping bushing 16 comprise three latching springs 18 which each have three latching hooks 20, wherein the latching springs 18 and latching hooks 20 are arranged on the clamping bushing 16 over an angular extent of 120°.

Accordingly, a total of three insertion-limiting stops 21 are provided, which insertion-limiting stops are likewise in each case distributed on the outer circumference of the clamping bushing 16 over an angular extent of 120°.

In the two exemplary embodiments, the side walls 24 of the insertion-limiting stops 21 are of flexible design, and therefore, when the threaded stem 6 of the fastening screw 5 is pressed into the receiving space 17, the clamping jaws 23 can execute a yielding movement. For this purpose, it can be provided, for example, that the side walls 24 of the insertion-limiting stops 21 have film-hinge-like thin points in the region of the deflection thereof.

FIGS. 9a to 9c show a further exemplary embodiment of a captive retaining means for a housing cover according to the invention. In this example too, the housing cover or the oil sump 1 is illustrated only in the region of the penetration opening 4. The penetration opening 4 comprises a receiving pocket 25 which forms a partially encircling undercut of the penetration opening 4, wherein the receiving pocket 25 forms a lateral window 26 into which a clamping bushing 16 is inserted laterally. The width of the window 26 corresponds approximately to the outside diameter of the clamping bushing 16. Furthermore, the outside diameter of the clamping bushing 16 is of a larger size than the clear width of the penetration opening 4. The clamping bushing 16 is held within the receiving pocket 25 by the fastening screw 5 inserted through the receiving space 17 of said clamping bushing. As can be gathered in particular from FIGS. 9c and 9d, the threaded stem 6 of the fastening screw 5 passes through the receiving space 17 of the clamping bushing 16 arranged in the receiving pocket 25, wherein the threaded stem 6 is held within the receiving space 17 by three clamping jaws 23 arranged over an angular extent of 120°. The clamping jaws 23 are designed as cam-shaped projections in the receiving space 17 and engage around the fastening screw 5 in the manner of a press fit.

Furthermore, cams 27, the extent and number of which determine the rigidity of the clamping bushing 16 are provided on the outer circumference of the clamping bushing 16. The desired clamping force applied to the threaded stem 6 of the fastening screw 5 can be set via the extent and number of cams 27.

A fourth exemplary embodiment of the captive retaining means on the housing cover according to the invention is illustrated in FIGS. 10a to 10c. The penetration opening 4 in the oil sump is lowered on both sides such that said penetration opening has on both sides, i.e. both on the side facing the screw head 7 and on the side facing the connection component, a diameter which is larger than the outside diameter of the clamping bushing 16, and therefore a receiving pocket 25 for the clamping bushing 16 is formed in each case at both ends of the penetration opening 4. Furthermore, the cross section of the duct opening 4 is constricted, to be precise to a size which is approximately 25% larger than the nominal diameter of the fastening screw 5. The clamping bushing 16 according to the exemplary embodiment illustrated in FIGS. 10a to 10c otherwise corresponds to the clamping bushing 16 according to the exemplary embodiment illustrated in FIGS. 9a to 9e. By means of the mutually opposite arrangement of two clamping bushings 16 at a distance from each other, axial securing of the fastening screw 5 both in the tightening direction and in the release direction is achieved. Owing to the fact that the diameter of the receiving pocket 25 is significantly larger than the outside diameter of the clamping bushings 16, the clamping bushings 16 can shift in the circumferential direction, and therefore compensation for positional tolerances of the actuating screw 5 is thereby ensured.

### LIST OF REFERENCE NUMBERS

1 Oil sump

2 Gearbox housing

3 Fastening flange

4 Penetration openings

5 Fastening screws

6 Threaded stem

7 Screw head

8 Hexagon socket

9 Fastening eye

10 Bearing surface

11 Sealing ring

12 Groove

13 Threaded bore

14 Sealing surface of the fastening flange

15 Separating gap

16 Clamping bushing

17 Receiving space

18 Latching springs

19 Sliding ramps

20 Latching hook

21 Insertion-limiting stop

22 Latching projection

23 Clamping jaws

24 Side walls

25 Receiving pocket

26 Window

27 Cam

1. Captive retaining means for a fastening screw on a component, said fastening screw passing through a penetration opening in the component, wherein the component can be arranged with respect to a connection component in such a manner that the penetration opening is approximately aligned with a connection opening in the connection component, and that the fastening screw is insertable into the connection opening, wherein the captive retaining means comprises at least one first clamping bushing which engages around a threaded stem of the fastening screw and is in engagement with said threaded stem in such a manner that the threaded stem is fixed non-positively in the clamping bushing, wherein the clamping bushing is fixed axially in the penetration opening, characterized in that the clamping bushing is inserted directly into the penetration opening, and in that the clamping bushing can be shifted freely in the radial direction in the penetration opening.

2. Captive retaining means according to claim 1, characterized in that the component is composed of thermoplastic.

3. Captive retaining means according to claim 1, characterized in that the component has a receiving pocket for the clamping bushing, wherein the receiving pocket forms an undercut of the penetration opening.

4. Captive retaining means according to claim 3, characterized in that the receiving pocket has at least one window which defines a circumferential break-through of the penetration opening and through which the clamping bushing is insertable into the receiving pocket, wherein the outside diameter of the clamping bushing is larger than the clear width of the penetration opening.

5. Captive retaining means according to claim 1, characterized in that the clamping bushing is latched axially in the penetration opening.

6. Captive retaining means according to claim 5, characterized in that the clamping bushing has at least two latching springs which engage behind at least one latching projection in the duct.

7. Captive retaining means according to claim 6, characterized in that the clamping bushing has at least one insertion-limiting stop which is supported on an encircling collar in the penetration opening, wherein the collar forms a latching projection, behind which the latching springs engage.

8. Captive retaining means according to claim 5, characterized in that the outside diameter of the clamping bushing is partially smaller than the clear width of the penetration opening.

9. Captive retaining means according to claim 1, characterized in that a second clamping bushing is provided, said clamping bushing engaging around the stem of the fastening screw at a distance from the first clamping bushing, wherein the clamping bushings are each supported on an encircling step or on a plurality of projections in the penetration opening.

10. Captive retaining means according to claim 1, characterized in that the clamping bushing has inwardly projecting clamping jaws or clamping cams which form an interference fit with the stem of the fastening screw.

11. Captive retaining means according to claim 1, characterized in that the clamping bushing is composed of thermoplastic.

12. Captive retaining means according to claim 1, characterized in that the component is designed as a housing cover for an engine housing or gearbox housing, in particular as a gearbox oil sump or engine oil sump made from thermoplastic and has a fastening flange with a plurality of penetration openings arranged at a distance from one another.
